(19) United States
(12) Patent Application Publication
(10) Pub. No.: US 2015/0233857 A1
(43) Pub. Date: Aug. 20, 2015

(54) TEST METHOD AND DEVICE

(71) Applicant: ANALOG DEVICES GLOBAL, Hamilton (BM)

(72) Inventors: Paul Martin Lambkin, Carrigaline (IE); William Allan Lane, Waterfall (IE)

(21) Appl. No.: 14/183,046

(22) Filed: Feb. 18, 2014

(51) Int. Cl. G01N 27/20; G01N 27/14

(52) U.S. Cl. CPC G01N 27/20; G01N 27/14

(57) ABSTRACT

Methods, devices and electronic components are disclosed, including a method of testing an integrity of a reduced gas pressure region at at least part of an electronic device, the method comprising applying a first current or voltage to a conductor, wherein the conductor includes at least one thermocouple formed on the device, and measuring an electrical property of the device.

### FIELD

Embodiments described herein relate to a test method and device, for example for testing gas pressure adjacent to the device.

### BACKGROUND

Thermocouple based sensors are known where a thermocouple junction is formed in close proximity to an infrared receiving area. The heating energy delivered per unit area by infrared (IR) radiation arriving at the thermocouple and/or at an IR receiving area associated with the thermocouple can be quite small, and it is desirable to make best use of it.

It is desirable to surround at least part of the sensor, such as the IR receiving area, with a vacuum. This is so that there is little or no gas in contact with the receiving area, which would conduct heat away from the IR receiving area and reduce the sensitivity of the sensor.

The integrity of the vacuum could be determined using a separate pressure gauge, such as a Pirani gauge. However, constructing such a gauge for use with a semiconductor-based sensor may be difficult or may be incompatible with the semiconductor manufacturing process.

### SUMMARY

According to one embodiment, there is provided a method of testing an integrity of a reduced gas pressure region adjacent or surrounding at least part of an electronic device, the method comprising applying a first current or voltage to a conductor, wherein the conductor includes at least one thermocouple formed on the device; and measuring an electrical property of the device.

According to another embodiment, there is provided an electronic component comprising at least one device, a conductor including at least one thermocouple formed on the device, and a control module for testing an integrity of a reduced gas pressure region adjacent or surrounding at least part of the device, wherein the control module is arranged to apply a first current or voltage to the conductor and measure an electrical property of the device.

### BRIEF DESCRIPTION OF THE DRAWINGS

Embodiments will now be described by way of example only with reference to the accompanying Figures, in which:

FIG. 1 shows an example of a radiation sensor device;

FIG. 2 shows an example of a portion of the device of FIG. 1;

FIG. 3 shows a further example of a radiation sensor device;

FIG. 4 shows a graph illustrating current-voltage characteristics of devices under different pressures;

FIG. 5 shows a further graph illustrating voltage or temperature response of a device to a biasing pulse;

FIG. 6 shows another graph illustrating voltage response of a device to a short biasing pulse;

FIG. 7 shows a further graph illustrating voltage response of a device to a biasing pulse; and

FIG. 8 shows an example of an electronic component.

### DETAILED DESCRIPTION OF THE PREFERRED EMBODIMENT

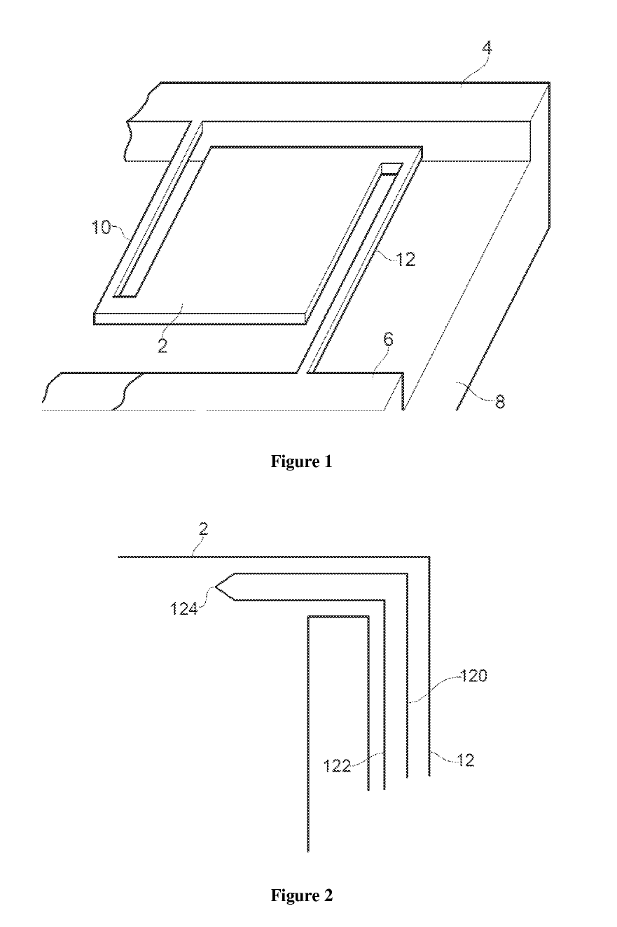

A first embodiment of an infrared radiation sensor device is schematically illustrated, in perspective view, in FIG. 1. A platform 2, which is formed by masking and etching steps commonly available in semiconductor fabrication processes, is held attached to a supporting structure, such as walls 4 and 6 standing proud of a substrate 8 such that a gap is formed between the platform 2 and the underlying remaining substrate 8. The platform 2 is held attached to the walls 4 and 6 by slender supporting legs 10 and 12 which provide an elongate and thin connection between the platform 2 and the walls 4 and 6, and thereby hold it over the substrate 8. This thin and elongate path provides a high thermal impedance between the platform 2 and the substrate 8. This is beneficial as infrared (IR) radiation impinging on the platform 2 raises the temperature of the platform above that of the substrate in order for the intensity of the radiation to be measured by the sensor.

The legs in the embodiment shown in FIG. 1 are attached at opposing corners of the platform 2. This gives good structural reliability whilst forming an elongate thermal path. The platform may be connected in other ways. The connection(s) could be made midway along the sides of the table, and the connection, or each connection, could be made to a single wall.

The platform need not be square or rectangular, and other shapes such as triangular, polygonal (such as hexagonal or octagonal) or circular platform shapes may be used. The legs 10 and/or 12 may be arranged to be meandering and may have several folds in them, and/or may wrap or circle around part of the platform, but in a plane parallel with the surface of the platform 2.

The slender or elongate legs present a length which is several, for example >3, times their width, thereby providing good isolation from heat conduction between the platform 2 and the walls 4 and 6 of the substrate.

Reduction of conduction of heat away from the platform 2 is achieved by reducing gas pressure (compared to atmospheric pressure) in a region adjacent or around the platform 2. For example, conduction is minimized by placing the substrate, or at least the part of it that carries the platform 2, or an array of such platforms, within an evacuated region including the gap between the platform 2 and the substrate 8. Such an evacuated region may be formed for example by placing the entirety of the substrate in an evacuated case having an infrared window to admit infrared radiation onto the platform 2, and/or a cover may be bonded directly to the substrate, using suitable spacing components.

In some embodiments, the platform 2 may be non-uniform, and/or may include structures formed thereon such as for example holes through the platform and/or structures standing proud of the platform such as pillars or hills on the upper surface of the platform (that is, the surface that faces in the direction from which infrared radiation is expected to be received). Such structures may reduce the mass of the platform and/or improve the ability of the platform to absorb infrared radiation.

An electronic component such as an infrared imaging component may include a single device such as that shown in FIG. 1 or may include a plurality of such devices. One of the devices among the plurality could be used as a test device for testing the integrity of the vacuum surrounding the device, or the part of the device that is within a vacuum. Additionally or alternatively, a similar or identical device could be used as a dedicated test device.

The device of FIG. 1 includes at least one conductor, not shown in FIG. 1, but shown in part in FIG. 2. This shows a corner of the platform 2 of FIG. 1 and a single leg 12. The leg has two tracks of dissimilar conductors, such as polysilicon having different doping types (n or p type) or concentrations, identified as items 120 and 122 respectively. The tracks form dissimilar conductors that meet at a junction 124 forming the “hot” junction of a thermocouple. Thus, the device includes a conductor that comprises at least the tracks 120 and 122 and the thermocouple junction 124. “Cold” junctions can be formed at the interface between the polysilicon tracks 120 and 122 and metal conductors on the substrate 2 or in or on the walls 4 and 6 (see FIG. 1 or 2). Thus the conductor shown extends between the platform 2 and the substrate.

In some embodiments, another thermocouple may be formed adjacent a further leg (such as the other leg 10), and the thermocouples can be connected in series to form a thermopile. Other suitable materials such as silicon germanium (SiGe), Bi₂Te₃, Sb₂Te₃, etc may be used in place of the polysilicon. For example, the hot junction or junctions may be formed at the interface of differently doped SiGe conductors.

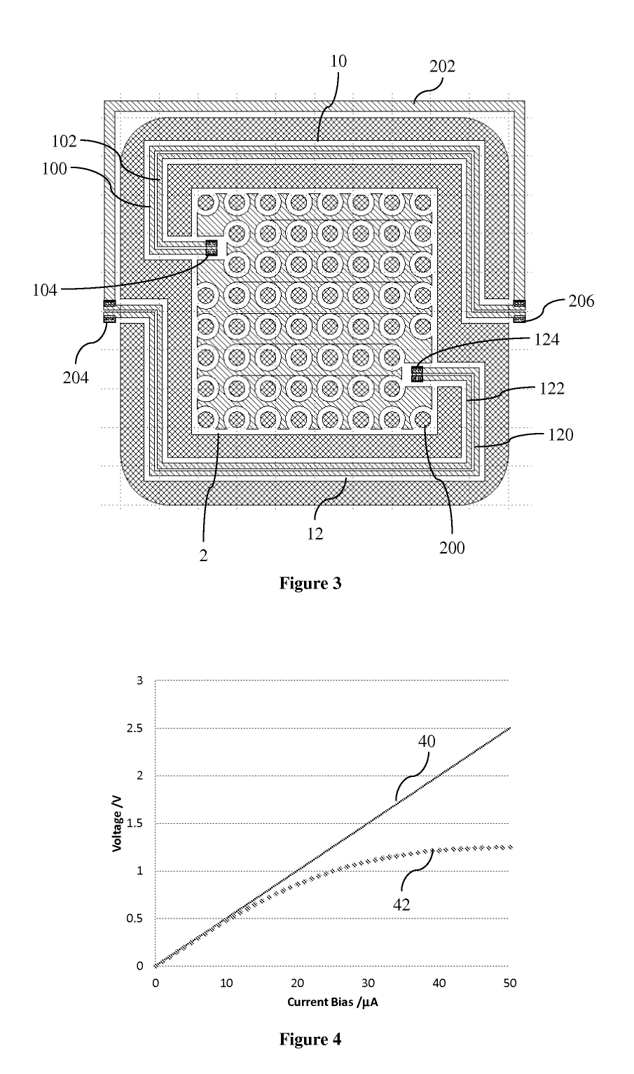

Further details of example embodiments of a device are shown in FIG. 3. FIG. 3 shows a plan view of an embodiment of a device that includes a thermopile comprising two series connected thermocouples. Features similar or identical to those shown in FIGS. 1 and 2 have been given identical reference numerals. The device includes a platform 2 supported by legs 10 and 12, the platform having a plurality of holes 200 (or pillars formed by etching trenches) to reduce its mass as explained above. It can be seen that the shape of the legs 10 and 12 and the points at which they attach to the platform 2 differs from that shown in FIGS. 1 and 3, and thus they illustrate a different example. The leg 12 includes tracks 120 and 122 having different doping types or concentrations that meet at a junction 124 to form a “hot” thermocouple junction. The leg 10 similarly includes tracks 100 and 102 having different doping types or concentrations that meet at junction 104 to form a second “hot” thermocouple junction. A conductive path 202 electrically connects the substrate ends of the tracks 100 and 122, thus forming a thermopile comprising a series connected pair of thermocouples between a pair of terminals 204 and 206. The terminals 204 and 206 may be connected to other electronic components (not shown). In other embodiments, even more thermocouple junctions may be included in the conductor (i.e., the thermopile), and any of the conductive tracks that form a thermocouple with another track may be formed on one of the legs that support the platform 2 or may be connected to the platform by some other means. The platform 2 itself may be supported by one or more supporting structures. FIGS. 1 and 3 show two supporting structures in the form of slender legs 10 and 12. The slender nature of the legs 10 and 12 ensures only a small amount of heat may be conducted from the platform via the legs 10, 12 to the substrate.

In some embodiments, a method of testing the integrity of a reduced gas pressure region (such as an evacuated region) adjacent or surrounding at least part of the device includes applying a first current or voltage to a conductor, wherein the conductor includes at least one thermocouple junction formed on the device, and measuring an electrical property of the device. The conductor may comprise dissimilar tracks as identified above. The electrical property of the device may comprise an electrical property of the conductor, such as its resistance, a current through the conductor with an applied voltage (i.e. the first current or voltage is a first voltage), or the voltage across the conductor with an applied current (i.e. the first current or voltage is a first current).

The resistance of at least part of the device, such as the conductor (comprising for example the conductive tracks and the thermocouple junction formed on the platform 2), may be dependent on a thermal conductance G of at least that part of the device. The thermal conductance G is dependent on the gas pressure adjacent or surrounding at least part of the device. In some embodiments, at least part of the device may be a polysilicon device whose resistance R is given or approximated by:

R(ΔT)=R₀(1+αΔT) (1)

Wherein α is the thermal coefficient of resistance (TCR). The relationship between current and voltage is:

$$\frac{I}{V} = \frac{1}{{R}_{0}} - \frac{α}{G} {I}^{2} \qquad ( 2 )$$

This can be rearranged to:

$$V = \frac{{GI}_{bias} {R}_{0}}{G - {I}_{bias}^{2} {R}_{0}} \qquad ( 3 )$$

The sensitivity of the voltage V to changes in pressure dependent G is therefore:

$$\frac{\partial V}{\partial G} = - \frac{α {I}_{bias}^{3} {R}_{0}}{α {I}_{bias}^{2} {R}_{0} - G} \approx - \frac{α {I}_{bias}^{3} {R}_{0}^{2}}{{G}^{2}} \qquad ( 4 )$$

The thermal conductance G is dependent on the pressure adjacent or surrounding at least part of the device, and thus the voltage V across the conductor with a certain applied current is also dependent on the gas pressure G. This can be exploited in some embodiments by applying for example a current through the conductor and measuring the voltage across the conductor. The resultant voltage, current-voltage characteristic or derived value, can be compared against a threshold voltage, current-voltage characteristic or derived value, to determine whether the pressure in the device is acceptably low.

FIG. 4 shows an example of a voltage/current characteristic of a test device both at “low” pressure, indicating a good vacuum integrity, and “high” pressure, indicating poor vacuum integrity. A poor vacuum may result in the pressure surrounding the device being close or equal to atmospheric pressure, for example, or at least significantly higher than a desired low pressure or vacuum. In this example, the resistance R₀ of the conductor is 50 kΩ, the TCR α is 0.004 and G is 0.5 μW/K. The voltage/current characteristic for high pressure is given by solid curve 40 whereas the characteristic for low pressure is given by dotted curve 42. It can be seen in FIG. 4 that when a bias current of, for example, 40 μA is applied through the conductor, the voltage across the conductor is around 1.2V at low pressure, and at around 2V for high pressure. Therefore, some embodiments may compare the measured voltage (or derived value) to a threshold, and may conclude that on one side of the threshold, the voltage (or derived value) indicates a “good” vacuum, whereas on the other side it indicates a “bad” vacuum. The level of the threshold and which side indicates a “good” vacuum may depend on the nature of the device and may also be determined through calibration for example.

In some embodiments, a method of testing occurs as follows. During a first time period, a current (or in some embodiments, a voltage) is applied across the device. For example, for the device shown in FIG. 3, a current is applied across terminals 204 and 206 such that the current flows through the thermopile. The current causes Joule heating of the conductor and thus of the legs 10 and 12. The current may also cause Peltier heating or cooling at the junction depending on the current direction, thus in some embodiments the current direction is chosen to cause Peltier heating. The legs may be heated during a relatively short time period. Over a relatively longer time period, heat from the legs 10 and 12 conducts to the platform 2. As a result, the voltage across the conductor may rise indicating that the temperature at the thermocouple junctions 104 and 124 has risen. However, while the temperature may rise to one level if the gas pressure adjacent or surrounding at least part of the device is low, the temperature may not rise to such a level if the gas pressure is high, due to the increased conductance of the gas. Similarly, once the bias current is removed, the legs and platform will cool faster in the presence of a high gas pressure. Thus, in some embodiments the testing method further comprises removing the current (or voltage) after the first time period, providing substantially no current or voltage to the conductor for a second time period during which the device cools, and then measuring an electrical property of the device. The electrical property can be compared to a threshold value. In some embodiments, this property is the voltage across the conductor that arises due to the Seebeck effect.

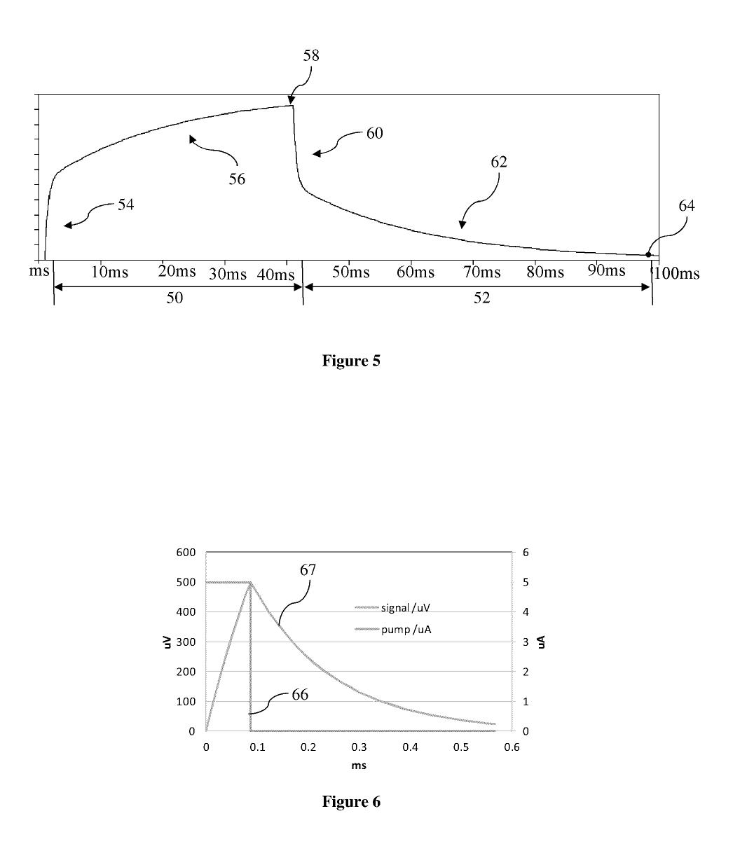

FIG. 5 shows an example of voltage across the conductor against time for an example embodiment. During a first time period 50, a bias current of 5 μA is applied through the conductor, and during a second time period 52 no bias current is applied. It can be seen that in a first region generally indicated as 54 the voltage, which represents the temperature of the thermocouple or thermocouples along the conductor, rises quickly, showing the fast Joule heating of the legs supporting the platform. In a second region 56, the temperature rises more slowly, representing conduction of heat from the legs to the platform. At a point 58 at the end of the first time period 50, the maximum temperature for the test has been reached.

In the second time period 52, when there is no bias current, the platform and legs cool. During a region 60, the temperature drops relatively quickly due to cooling of the legs supporting the platform. During a region 62, the temperature drops more slowly due to cooling of the platform. The cooling is faster in the presence of higher gas pressure due to the increased cooling by convection of the gas.

In the presence of higher gas pressure, therefore, at the end of the first time period 50 the temperature is not as high as in the presence of low gas pressure, and may also cool more quickly in the second time period 52. Therefore, comparison of the voltage across the conductor (and hence the temperature) after the second time period 52, for example at a point 64, with a threshold may indicate whether the gas pressure is high or low and hence whether the device is a “good” device or a “bad” device.

FIG. 6 shows another similar procedure with another example embodiment. In a short first time period lasting 87 μs a current of about 5 μA is applied as shown by the line 66, and drops to zero after this time period. In the first time period the voltage across the conductor, indicated by the line 67, rises to around 500 μV and starts to fall again after the first time period. After a second time period, the voltage (and hence temperature) can be measured and compared to a threshold.

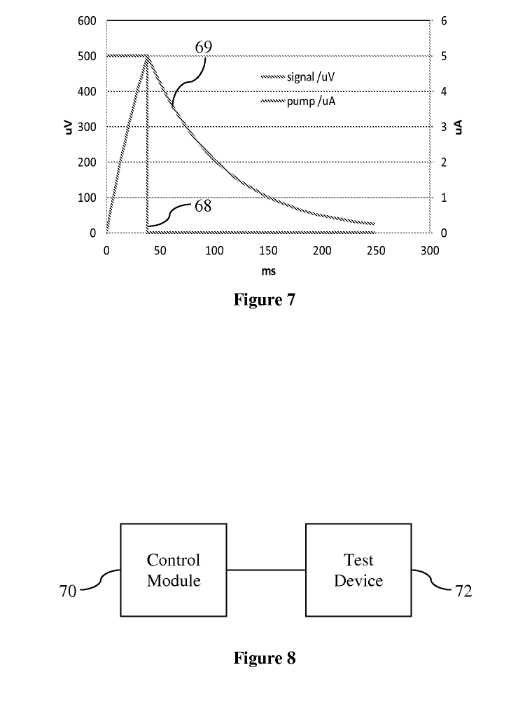

FIG. 7 shows another similar procedure with another example embodiment. In a first time period lasting 40 ms a current of about 5 μA is applied and subsequently drops to zero, as indicated by line 68. In the first time period in this example the voltage across the conductor, indicated by the line 69, rises to around 500 μV and starts to fall again after the first time period. After a second time period, the voltage (and hence temperature) can be measured and compared to a threshold. A longer pulse (as shown in FIG. 7 for example) may generally transfer more heat to the platform due to conduction from the supporting legs to the platform for example, and thus may indicate the response of the whole device including the legs and the platform, whereas a shorter pulse (as shown in FIG. 6 for example) may indicate the response of the legs only as less heat is provided to the platform, and thus may indicate the response of substantially the legs only.

FIG. 8 shows an example embodiment of an electronic component that includes a control module 70 and a test device 72. The electronic component may include other devices and components, not shown in FIG. 6. For example, the component may include an array of infrared sensing devices that forms an imaging device. The test device 72 may be one of the sensors in the array or may be a dedicated test device or test sensor.

The control module 70 is connected to the test device 72 and is arranged to perform a test method for testing the integrity of an evacuated region adjacent or surrounding at least part of the test device 72. The evacuated region may also surround other components. The control module 70 may also be arranged to measure an electrical property of the device 72, for example the voltage across a conductor associated with the device 72. Such measurements may also include measuring the resistance of the device, or the thermocouple response after heating one of the sensors in an IR sensor array.

In some embodiments, a test method may be performed at the time a device or component is manufactured. Additionally or alternatively, a test method may be performed as an ongoing process, for example during operation of the device or component, for testing of reduced gas pressure integrity and performance periodically, upon start-up of the device, or with each use.

The formation of embodiments will be evident to the person skilled in the art. However, for the sake of completeness, a brief overview of an example is given here. Standard CMOS processes may be employed up to passivation, during which the thermocouples or thermopiles are formed, and any metal layers associated with the platform, or each platform, are appropriately patterned. Standard CMOS processes allow for a plurality of metal layers (often 6) to be formed over the substrate with silicon oxide as insulators therebetween. In the device, such as the platform and/or legs, none or only one of the layers need be provided. The passivation is then selectively opened and the underlying silicon is etched to define the limit of the table, or each table, and its legs. The table may be structured with surface structures or may be uniform and smooth. Finally an isotropic etch (e.g., using XeF₂) is used to remove silicon from under the table, thereby releasing it to create the gap between the platform and the underlying substrate. Other fabrication options include micromachining the semiconductor wafer. The completed wafer may then be packaged in an evacuated package, which may include features for forming an aperture to control a field of view.

In some embodiments, if the test device is identical to other devices on an electronic component, such as other infrared sensors in an array, and this may ease the manufacturing process. In such embodiments, one of the devices in the array may be used as a test device, either permanently or only at the time of testing, or a dedicated test device outside the array may be provided. In other embodiments, however, the test device may not be identical to the other devices.

In some embodiments, a further test device may be provided that is not contained within or adjacent to a reduced gas pressure region such as a vacuum region. In such embodiments, the test device that is adjacent or within the vacuum may be used along with the further device to obtain a differential measurement of an electrical property of the test device. This arrangement may reduce or eliminate the effect of any variation of the devices due to the manufacturing process. For example, the further device may provide a reference property (such as resistance) which can be compared to the property of the test device. The electrical property in some embodiments could then comprise the differential measurement, i.e., the difference between the properties of the two devices. In some embodiments, the devices may form a Wheatstone bridge for performing a differential measurement of the resistance of the test device.

The platform 2 may also include a conductive track on or adjacent the platform such that the platform can be subjected to ohmic (Joule) heating for test or calibration purposes.

Although methods, devices and electronic components have been disclosed in the context of certain preferred embodiments and examples, it will be understood by those skilled in the art that this disclosure extends beyond the specifically disclosed embodiments to other alternative embodiments and/or uses and obvious modifications and equivalents thereof. In addition, while several variations have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the disclosed embodiments. Thus, it is intended that the scope of the present invention herein disclosed should not be limited by the particular disclosed embodiments described above, but should be determined only by a fair reading of the claims that follow.

What is claimed is:

1. A method of testing an integrity of a reduced gas pressure region at at least part of an electronic device, the method comprising:
applying a first current or voltage to a conductor, wherein the conductor includes at least one thermocouple formed on the device; and
measuring an electrical property of the device.

2. The method of claim 1, further comprising comparing the electrical property to a threshold.

3. The method of claim 1, wherein the first current or voltage comprises a first current.

4. The method of claim 1, wherein applying the first current or voltage to the conductor comprises applying the first current or voltage for a first time period, and measuring an electrical property of the device comprises measuring the electrical property after the first time period.

5. The method of claim 4, wherein measuring the electrical property comprises measuring a voltage or current across the conductor due to a Seebeck effect.

6. The method of claim 5, comprising measuring the electrical property of the device after a second time period following the first time period, wherein substantially no current or voltage is applied to the conductor during the second time period.

7. The method of claim 1, wherein the device includes a platform supported over a substrate by at least one support structure, and the conductor extends between the substrate and the platform, and wherein the thermocouple is formed on the platform.

8. The method of claim 1, wherein measuring the electrical property of the device comprises measuring a current or voltage across the conductor or a resistance of the conductor.

9. The method of claim 1, wherein the device is an infrared sensor.

10. The method of claim 1, wherein measuring an electrical property of the device comprises obtaining a differential measurement by comparing the first current or voltage across the conductor with a further current or voltage across a further conductor of a further device.

11. The method of claim 10, wherein the further device is not adjacent or within the reduced gas pressure region.

12. The method of claim 1, further comprising determining the integrity of the reduced gas pressure region at the at least part of the device based on the electrical property of the device.

13. An electronic component comprising:
at least one device;
a conductor including at least one thermocouple formed on the device; and
a control module for testing an integrity of a reduced gas pressure region at at least part of the device, the control module arranged to apply a first current or voltage to the conductor and measure an electrical property of the device.

14. The electronic component of claim 13, wherein the control module is arranged to compare the electrical property to a threshold.

15. The electronic component of claim 13, wherein the first current or voltage comprises a first current.

16. The electronic component of claim 13, wherein the control module is arranged to apply the first current or voltage to the conductor by applying the first current or voltage for a first time period, and the control module is arranged to measure the electrical property after the first time period.

17. The electronic component of claim 16, wherein the control module is arranged to measure the electrical property by measuring a voltage or current across the conductor due to a Seebeck effect.

18. The electronic component of claim 17, wherein the control module is arranged to measure the electrical property of the device after a second time period following the first time period, wherein substantially no current or voltage is applied to the conductor during the second time period.

19. The electronic component of claim 13, wherein the device includes a platform supported over a substrate by at least one support structure, and the conductor extends between the substrate and the platform, and wherein the thermocouple is formed on the platform.

20. The electronic component of claim 13, wherein measuring the electrical property of the device comprises measuring a current or voltage across the conductor or a resistance of the conductor.

21. The electronic component of claim 13, wherein the device is an infrared sensor.

22. The electronic component of claim 13, further comprising a further electronic device, and wherein the control module is arranged to measure the electrical property of the device by obtaining a differential measurement by comparing the first current or voltage across the conductor with a further current or voltage across a further conductor of a further device.

23. The electronic component of claim 13, wherein the further device is not adjacent or within the reduced gas pressure region.

24. The electronic component of claim 13, wherein the control module is further arranged to determine the integrity of the reduced gas pressure region at the at least part of the device based on the electrical property of the device.
